(19) United States
(12) Patent Application Publication
(10) Pub. No.: US 2010/0112979 A1
(43) Pub. Date: May 6, 2010

(54) WIRELESS ACCESS DEVICE AND PAIRING METHOD

(75) Inventors: Chien-Hua Chen, Tu-Cheng (TW); Yu-Hsin Lin, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/429,173

(22) Filed: Apr. 23, 2009

(30) Foreign Application Priority Data
Oct. 31, 2008 (CN) 200810305321.7

(51) Int. Cl. H04M 3/16

(52) U.S. Cl. 455/411

(57) ABSTRACT

A wireless access device for pairing with a wireless communication device by a plurality of signal lamps. The wireless access device stores a lamp-code mapping table including a plurality of lamp states and corresponding pairing codes to the plurality of the lamp states, turns off an encryption mechanism of the wireless access device, randomly selects one lamp state from the lamp-code mapping table, controls states of the plurality of signal lamps according the selected lamp state, receives a pairing request from the wireless communication device, obtains a pairing code from the pairing request, pairs with the wireless communication device when the obtained pairing code matches the pairing code corresponding to the selected lamp state, and rejects pairing with the wireless communication device if the obtained pairing code does not match the pairing code corresponding to the selected lamp state. A pairing method is also provided.

### BACKGROUND

1. Field of the Invention

Embodiments of the disclosure relate to network access, and particularly to a wireless access device and a pairing method.

2. Description of Related Art

Security is an important performance of wireless communication devices. Therefore, many wireless communication devices is operated under a wireless encryption mechanism, such as wired equivalent privacy (WEP), WI-FI protected access (WPA), or WPA2. A wireless phone need to pair with a wireless access device and obtain an encryption key of the wireless encryption mechanism. The wireless phone pairs with the wireless access device according to hypertext transfer protocol secure (HTTPS). A user of the Wi-Fi phone presses a pairing button on the wireless phone and the wireless phone will send a pairing request with the use of HTTPS to the wireless access device. Upon receipt of the request, the wireless access device will respond with an encryption key in a XML format. Whenever the HTTPS handshake completes, the wireless device and the wireless phone will enable their wireless encryption with that encryption key. Then the wireless access device can communicate with the wireless phone under the wireless encryption mechanism.

In order to allow the wireless phone to connect to the wireless access device before the pairing request starts, the wireless device's encryption shall remain disabled. However, if it happens that an unauthorized wireless phone sends a pairing request earlier than an authorized wireless phone, the wireless access device will take the request from the unauthorized wireless phone and reject the one from the authorized wireless phone, which reduces satisfaction of users of the authorized wireless phone. In addition, the unauthorized wireless phone can communicate with the wireless access device and obtain the encryption key and encrypted data, which extraordinarily damages communication security.

### BRIEF DESCRIPTION OF THE DRAWINGS

The details of the disclosure, both as to its structure and operation, can best be understood by referring to the accompanying drawings, in which like reference numbers and designations refer to like elements.

FIG. 1 is a schematic diagram of an application environment and functional modules of a wireless access device of the disclosure;

FIG. 2 is a schematic diagram of a lamp-code mapping table utilized in the device of FIG. 1 and method of FIG. 3; and

FIG. 3 is a flowchart of a pairing method for a wireless access device with a wireless communication device in accordance with the disclosure.

### DETAILED DESCRIPTION

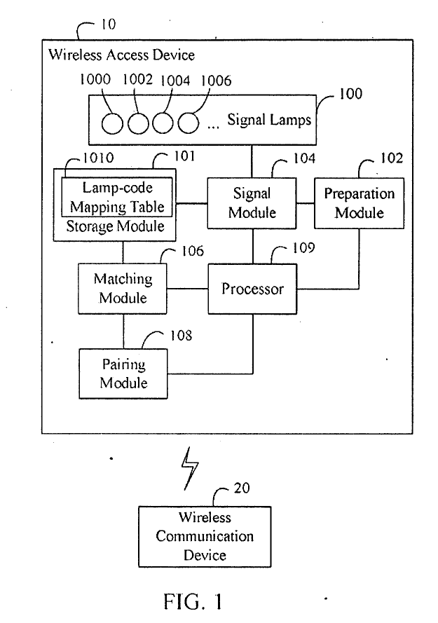

FIG. 1 is a schematic diagram of an application environment and functional modules of a wireless access device 10 of the disclosure. Here, the wireless access device 10 is configured for pairing with a wireless communication device 20. The pairing includes a plurality of actions to implement wireless communication between the wireless access device 10 and wireless communication device 20, such as identification and encryption key exchange. The wireless access device 10 can wirelessly communicates with the wireless communication device 20 utilizing hypertext transfer protocol secure (HTTPS) after the pairing. The wireless access device 10 may be an access point (AP). The wireless communication device 20 may be a telephone or a computer.

Here, the wireless access device 10 includes a plurality of signal lamps 100 which can, for example, be light emitting diodes (LEDs). States of the plurality of signal lamps include lit, off, and blinking. Further, the plurality of signal lamps can include additional states such as changing color.

Here, the wireless access device 10 includes a storage module 101, a preparation module 102, a signal module 104, a matching module 106, a pairing module 108, and a processor 109. The processor 109 controls the storage module 101, the preparation module 102, the signal module 104, the matching module 106, and the pairing module 108.

The storage module 101 stores a lamp-code mapping table 1010. Here, the lamp-code mapping table 1010 may be prepared earlier and stored in the wireless access device 10, and includes a plurality of lamp states and pairing codes corresponding thereto. The pairing codes identify whether the wireless communication device 20 is authorized. The pairing codes may be capital letters, lowercase letters, numbers, or combination thereof. Here, the storage module 101 may be a flash of the wireless access device 10.

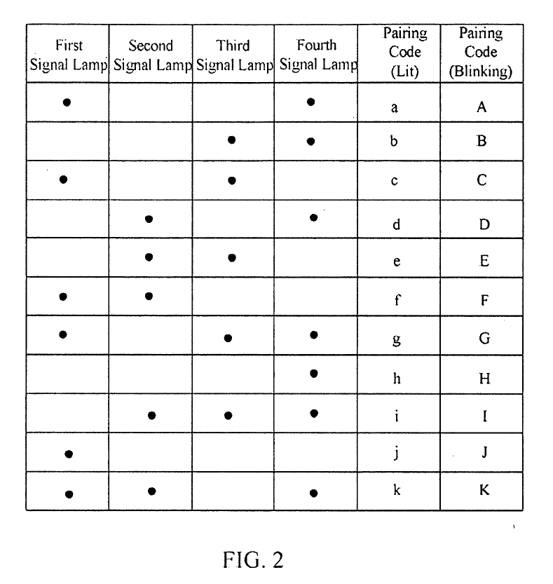

FIG. 2, a schematic diagram of a lamp-code mapping table utilized in the disclosure, shows four signal lamps for example, a first signal lamp 1000, a second signal lamp 1002, a third signal lamp 1004, and a fourth signal lamp 1006. The lamp-code mapping table 1010 can be preset as a plurality of lamp states and corresponding pairing codes. For example, the lamp states of the first signal lamp 1000 and the fourth signal lamp 1006 can be preset as lit, the lamp states of the second signal lamp 1002 and the third signal lamp 1004 are preset as off, and the corresponding pairing code to the lamp states is preset as “a.” The lamp states of the first signal lamp 1000 and the fourth signal lamp 1006 are preset as blinking, the lamp states of the second signal lamp 1002 and the third signal lamp 1004 are preset as off, and the corresponding pairing code to the lamp states is preset as “A.” It is noted that FIG. 2 does not indicate all possible combinations of lamp states. Additionally, the lamp-code mapping table 1010 may be printed directly on the wireless access device 10 for the convenience of authorized users.

Referring to FIG. 1, the preparation module 102 is configured for turning off an encryption mechanism of the wireless access device 10 when receiving a pairing start signal to prepare for pairing with the wireless communication device 20. In order to ensure that the wireless communication device 20 can associate with the wireless access device 10 before the pairing request starts, the wireless encryption on the wireless access device 10 must be turned off.

The signal module 104 is configured for randomly selecting one lamp state from the lamp-code mapping table 1010 and controlling states of the plurality of signal lamps 100 accordingly. For example, if the selected lamp state is the first signal lamp 1000 and the fourth signal lamp 1006 lit and the second signal lamp 1002 and the third signal lamp 1004 off, then the signal module 104 lights the first signal lamp 1000 and the fourth signal lamp 1006 and turns off the second signal lamp 1002 and the third signal lamp 1004. Authorized users can accordingly obtain the pairing code according to the lamp states of the signal lamps 100 and the lamp-code mapping table 1010 shown on the wireless access device 10, namely “a”. The wireless communication device 20 will send a pairing request with the use of HTTPS to the wireless access device 10 if it wishes to pair with the wireless access device 10. The pairing request may be as follows: “https://IP_address/pair/a”, wherein the IP_address is an Internet protocol address of the wireless access device 10 and “a” is the obtained pairing code.

The matching module 106 is configured for receiving the pairing request from the wireless communication device 20, obtaining the pairing code from the pairing request, and determining whether the obtained pairing code matches the pairing code corresponding to the selected lamp state. If so, the wireless communication device 20 is authorized. If not, the wireless communication device 20 is not authorized and the pairing request will be declined.

The pairing module 108 is configured for pairing with the wireless communication device 20 when the obtained pairing code matches the pairing code corresponding to the selected lamp state and rejecting pairing with the wireless communication device 20 when the obtained pairing code does not match the pairing code corresponding to the selected lamp state. Here, the pairing module 108 sends an extensible markup language (XML) file to the wireless communication device 20 to pair with the wireless communication device 20. The XML file includes an encryption key. Once the HTTPS handshake completes, the wireless access device 10 will enable its wireless encryption using the encryption key, and any other wireless communication devices which does not have the key will not be able to gain the access to the wireless access device 10, and that will greatly improves security of communication.

The signal module 104 is further configured for controlling states of the plurality of signal lamps 100 to indicate successful pairing when the pairing module 108 successfully pairs with the wireless communication device 20 and controlling states of the plurality of signal lamps 100 to indicate failed pairing when the pairing module 108 rejects pairing with the wireless communication device 20. The states of the plurality of signal lamps 100 indicating success or failure are predetermined. For example, the signal module 104 may light all of the signal lamps 100 to indicate success, and turn off all of the signal lamps 100 to indicate failure.

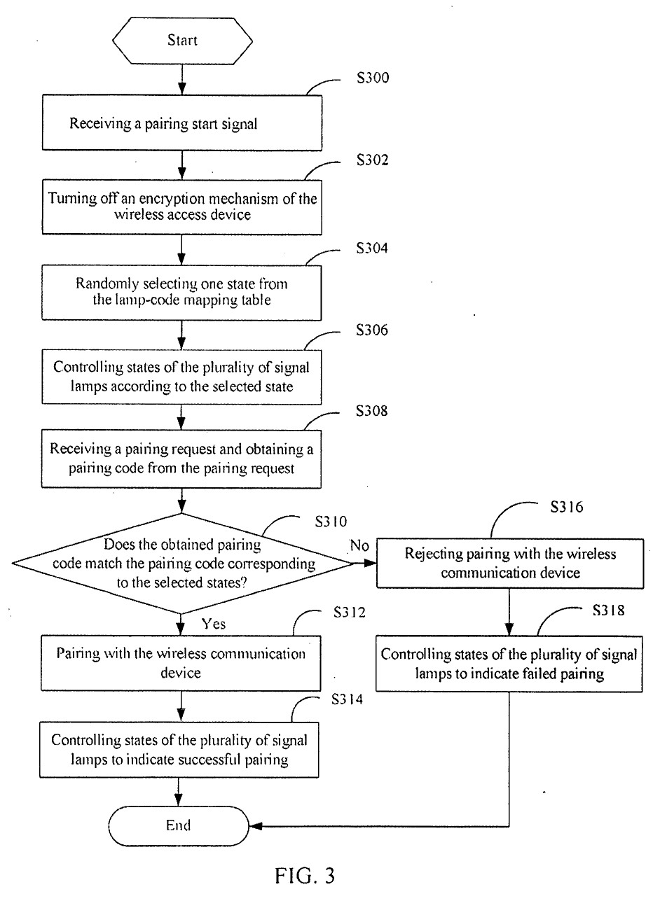

FIG. 3 is a flowchart of a pairing method of the wireless access device 10 with the wireless communication device 20 in accordance with the disclosure. Here, the pairing method is performed by the functional modules in FIG. 1.

In step S300, the preparation module 102 receives a pairing start signal.

In step S302, the preparation module 102 turns off an encryption mechanism of the wireless access device 10 to prepare for pairing.

In step S304, the signal module 104 randomly selects one lamp state from the lamp-code mapping table 1010. For example, if the signal module 104 selects one lamp state from the lamp-code mapping table 1010, which means to light the first signal lamp 1000 and the fourth signal lamp 1006 and turn off the second signal lamp 1002 and the third signal lamp 1004. The pairing code corresponding to the selected lamp state preset in the lamp-code mapping table 1010 is “a”.

In step S306, the signal module 104 controls states of the plurality of signal lamps 100 according to the selected lamp state. For example, if the signal module 104 selects the first signal lamp 1000 and the fourth signal lamp 1006 lit and the second signal lamp 1002 and the third signal lamp 1004 off, then the signal module 104 lights the first signal lamp 1000 and the fourth signal lamp 1006 and turns off the second signal lamp 1002 and the third signal lamp 1004.

In step S308, the matching module 106 receives the pairing request from the wireless communication device 20 and obtains the pairing code from the pairing request. For example, if the matching module 106 receives two pairing requests including “https://IP_address/pair/a” and “https://IP_address/pair/A” from two wireless communication devices 20, then the matching module 106 obtains the pairing code “a” and “A” from the two pairing requests.

In step S310, the matching module 106 determines whether the obtained pairing code matches the pairing code corresponding to the selected lamp state. Here, the matching module 106 obtains the pairing code corresponding to the selected lamp state in the lamp-code mapping table 1010, and then matches the pairing code obtained from the pairing request and the pairing code obtained from the lamp-code mapping table 1010. For example, the matching module 106 may obtain the pairing code “a” corresponding to the selected lamp state in the lamp-code mapping table 1010, and then match the pairing code “a” or “A” obtained from the pairing request and the pairing code “a” obtained from the lamp-code mapping table 1010. Therefore, the matching module 106 determines that the pairing code “a” obtained from the pairing request matches the pairing code “a” obtained from the lamp-code mapping table 1010, and the pairing code “A” obtained from the pairing request does not match the pairing code “a” obtained from the lamp-code mapping table 1010.

If the obtained pairing code matches the pairing code corresponding to the selected lamp state, which indicates that the wireless communication device 20 is authorized, then in step S312, the pairing module 108 pairs with the wireless communication device 20. Here, the pairing module 108 sends an extensible markup language (XML) file to the wireless communication device 20. The XML file includes an encryption key, which can be used for WEP, WPA, or WPA2.

In step S314, the signal module 104 controls states of the plurality of signal lamps 100 to indicate successful pairing.

If the obtained pairing code does not match the pairing code corresponding to the selected lamp state, which indicates that the wireless communication device 20 is not authorized, then in step S316, the pairing module 108 rejects pairing with the wireless communication device 20.

In step S318, the signal module 104 controls states of the plurality of signal lamps 100 to indicate failed pairing.

As such, authorized wireless communication devices can communicate with the wireless access device 10 and unauthorized wireless communication devices cannot communicate with the wireless access device 10, which greatly improves security of communication.

Although the features and elements of the disclosure are described as embodiments in particular combinations, each feature or element can be used alone or in other various combinations within the principles of the disclosure to the full extent indicated by the broad general meaning of the terms in which the appended claims are expressed.

What is claimed is:

1. A wireless access device configured for pairing with a wireless communication device by a plurality of signal lamps, the wireless access device comprising:
a storage module configured for storing a lamp-code mapping table comprising a plurality of lamp states and corresponding pairing codes to the plurality of lamp states, wherein the pairing codes are configured for identifying whether the wireless communication device is authorized;
a preparation module configured for turning off an encryption mechanism of the wireless access device when receiving a pairing start signal;
a signal module configured for randomly selecting one lamp state from the lamp-code mapping table and for controlling states of the plurality of signal lamps according to the selected lamp state;
a matching module configured for receiving a pairing request from the wireless communication device, obtaining a pairing code from the pairing request, and determining whether the obtained pairing code matches the pairing code corresponding to the selected lamp state;
a pairing module configured for pairing with the wireless communication device when the obtained pairing code matches the pairing code corresponding to the selected lamp state; and
at least one processor configured for controlling the preparation module, the signal module, the matching module, and the pairing module.

2. The wireless access device as claimed in claim 1, wherein the pairing module is further configured for sending an extensible markup language (XML) file comprising an encryption key to the wireless communication device to pair with the wireless communication device.

3. The wireless access device as claimed in claim 1, wherein the signal module is further configured for controlling states of the plurality of signal lamps to indicate successful pairing when the pairing module successfully pairs with the wireless communication device.

4. The wireless access device as claimed in claim 1, wherein the pairing module is further configured for rejecting pairing with the wireless communication device when the obtained pairing code does not match the pairing code corresponding to the selected lamp state.

5. The wireless access device as claimed in claim 4, wherein the signal module is further configured for controlling states of the plurality of signal lamps to indicate failed pairing when the pairing module rejects pairing with the wireless communication device.

6. The wireless access device as claimed in claim 1, wherein the plurality of lamp states comprise lit, off, and blinking.

7. A pairing method of a wireless access device with a wireless communication device by a plurality of signal lamps, comprising:
predetermining a lamp-code mapping table comprising a plurality of lamp states and corresponding pairing codes, wherein the pairing codes are configured for identifying whether the wireless communication device is authorized;
receiving a pairing start signal;
turning off an encryption mechanism of the wireless access device;
randomly selecting one lamp state from the lamp-code mapping table;
controlling states of the plurality of signal lamps according to the selected lamp state;
receiving a pairing request from the wireless communication device and obtaining a pairing code from the pairing request;
determining whether the obtained pairing code matches the pairing code corresponding to the selected lamp state; and
pairing with the wireless communication device if the obtained pairing code matches the pairing code corresponding to the selected lamp state.

8. The pairing method as claimed in claim 7, wherein pairing with the wireless access device with the wireless communication device comprises sending an extensible markup language (XML) file comprising an encryption key to the wireless communication device.

9. The pairing method as claimed in claim 7, further comprising controlling states of the plurality of signal lamps to indicate successful pairing.

10. The pairing method as claimed in claim 7, further comprising:
rejecting pairing with the wireless communication device if the obtained pairing code does not match the pairing code corresponding to the selected lamp state; and
controlling states of the plurality of signal lamps to indicate failed pairing.

11. The pairing method as claimed in claim 7, wherein the plurality of lamp states comprise lit, off, and blinking.
